(19) United States
(12) Patent Application Publication
(10) Pub. No.: US 2024/0381337 A1
(43) Pub. Date: Nov. 14, 2024

(54) USER EQUIPMENT PREDICTION METRICS REPORTING

(71) Applicant: GOOGLE LLC, Mountain View, CA (US)

(72) Inventors: Jibing Wang, San Jose, CA (US); Erik Richard Stauffer, Mountain View, CA (US)

(21) Appl. No.: 18/688,239

(22) PCT Filed: Sep. 7, 2022
(86) PCT No.: PCT/US2022/042735

§ 371 Date: Feb. 29, 2024

Related U.S. Application Data
(60) Provisional application No. 63/241,444, filed on Sep. 7, 2021.

(51) Int. Cl. H04W 72/12; H04W 72/542

(52) U.S. Cl. CPC H04W 72/12; H04W 72/542

(57) ABSTRACT

In aspects, a base station schedules air interface resources of a wireless communication system using one or more prediction metrics from a user equipment, UE. The base station receives (505), from the user equipment, user-equipment-prediction-metric capabilities. Based on the user-equipment-prediction-metric capabilities, the base station generates (510) a prediction-reporting request and communicates (515) the prediction-reporting request to the user equipment. The base station receives (520) one or more user-equipment-prediction-metric reports from the UE and schedules (525) the one or more air interface resources of the wireless communication system based on the one or more user-equipment-prediction-metric reports.

### CROSS-REFERENCE TO RELATED APPLICATIONS

This application claims the benefit of U.S. Provisional Patent Application No. US63/241,444, filed 7 Sep. 2021 the disclosure of which is incorporated herein by reference in its entirety.

### BACKGROUND

A radio access network (RAN) provides various data and/or voice services to user equipments (UEs) operating in the network. The operating requirements of each UE, however, may differ and/or dynamically change based on a current operating condition of the respective UE. To illustrate, a UE may initially have few data throughput and/or data-transfer latency demands while operating in the RAN. At a later point in time, however, assume the UE executes a particular application (e.g., a video conference call, online game,) that requires high data throughput and/or low data-transfer latency. As another example, a link configuration used for the UE's wireless link to the RAN (e.g., an allocation of air interface resources) may be inadequate for maintaining the wireless link as the UE moves to different locations and channel conditions change. Because these changes can occur rapidly, a base station providing the scheduling and/or allocation of air interface resources to the UE may have difficulty responding in time to these dynamic changes, resulting in a degraded user experience.

### SUMMARY

This document describes techniques and apparatuses for user equipment (UE) prediction metrics reporting. In aspects, a base station schedules air interface resources of a wireless communication system using one or more prediction metrics from a user equipment, UE. The base station receives, from the UE, user-equipment-prediction-metric capabilities. Based on the user-equipment-prediction-metric capabilities, the base station generates a prediction-reporting request and communicates the prediction-reporting request to the user equipment. The base station receives one or more user-equipment-prediction-metric reports from the UE and schedules (525) the one or more air interface resources of the wireless communication system based on the one or more user-equipment-prediction-metric reports.

In some aspects, a UE communicates one or more one or more prediction metrics to a base station. The UE generates a user-equipment-prediction-metric-capabilities communication that specifies one or more prediction metrics supported by the user equipment and transmits the user-equipment-prediction-metric-capabilities communication to the base station. In response, the UE receives, from the base station, a prediction-reporting request. Based on the prediction-reporting request, the UE generates one or more prediction metric reports based on the prediction-reporting request and transmits the one or more prediction metric reports to the base station.

The details of one or more implementations of UE prediction metrics reporting are set forth in the accompanying drawings and the following description. Other features and advantages will be apparent from the description, drawings, and claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

The details of one or more aspects of user equipment (UE) prediction metrics reporting are described below. The use of the same reference numbers in different instances in the description and the figures indicate similar elements:

FIG. 1 illustrates an example environment in which various aspects of UE prediction metrics reporting can be implemented;

FIG. 2 illustrates an example device diagram of devices that can implement various aspects of UE prediction metrics reporting;

FIG. 3 illustrates example air interface resources that can be utilized in accordance with various aspects of UE prediction metrics reporting;

FIG. 4 illustrates an example transaction diagram between various devices in accordance with various aspects of UE prediction metrics reporting;

FIG. 5 illustrates an example method that can be used to perform various aspects of UE prediction metrics reporting; and

FIG. 6 illustrates an example method that can be used to perform various aspects of UE prediction metrics reporting.

### DETAILED DESCRIPTION

Radio Access Networks (RANs) deliver services and/or connectivity to devices using wireless signals. A RAN, for instance, may include multiple base stations that each provide wireless access (e.g., cellular coverage) to the RAN over a designated area. User equipments exchange control-pane information and/or user-plane data with the base station(s) using various air interface resources (e.g., frequency bands, time slots, modulation and coding schemes) and protocols characterized by a supported radio access technology (RAT). Base stations and/or controllers schedule access to the air interface resources to mitigate transmission collisions, interference, and so forth, and improve the reliability and/or performance (e.g., increased capacity, improved signal quality, reduced errors) of the network system. For example, a base station schedules a first set of air interface resources to downlink transmissions for a first UE and a second, different set of air interface resources to uplink transmissions for a second UE to prevent collisions between the downlink transmissions and the uplink transmissions.

The evolution of wireless communication to fifth generation (5G) and sixth generation (6G) standards and technologies provides higher data rates and greater capacity with lower latency, which enhances mobile broadband services. Providing these services consistently to multiple UEs operating in the RAN, however, poses challenges due to dynamic changes in each UE's operating condition and/or location. To illustrate, the data throughput and/or data-transfer latency demands of each UE changes based on user interactions (e.g., user interactions that invoke or close applications). User mobility also introduces changes to a transmission environment as each UE moves to different locations with different channel conditions. A link configuration and/or allocation of air interface resources for a wireless link while the UE operates at a first location, for instance, may be inadequate for maintaining the wireless link at a second location with different channel conditions. A base station providing the scheduling and/or an allocation of air interface resources to the UE may have difficulty responding in time to these changes and result in a degraded user experience at the UE, such as dropped calls, slow data transfer, and/or insufficient data throughput.

In aspects, a UE provides prediction metrics to a base station based on various factors observable at and by the UE, such as a UE operating state (e.g., active and/or inactive applications, data priority, observed downlink data throughput, observed uplink data throughput, QoS requirements, uplink data priority, downlink data priority), UE-observed signal-quality parameters, UE-observed link-quality parameters, and so forth. As an example, the UE uses machine-learning (ML) algorithms to predict anticipated uplink and/or downlink data throughput requirements for a future time window and communicates the predicted throughput requirements to the base station. Thus, instead of communicating immediate throughput demands, the UE communicates predicted throughput demands for a future time window using information observable at the UE, which may not be observable to the base station. While described with respect to predicted throughput requirements, other prediction metrics may be communicated as further described. UE-generated prediction metrics provide the base station with additional information and time that can be used to improve how the base station schedules the air interface resources, such as scheduling that increases or decreases data throughput, reduces data-transfer latency, improves signal quality, etc., to meet the changes in demand and/or channel conditions. This also improves the reliability of the services provided by the RAN.

### Example Environment

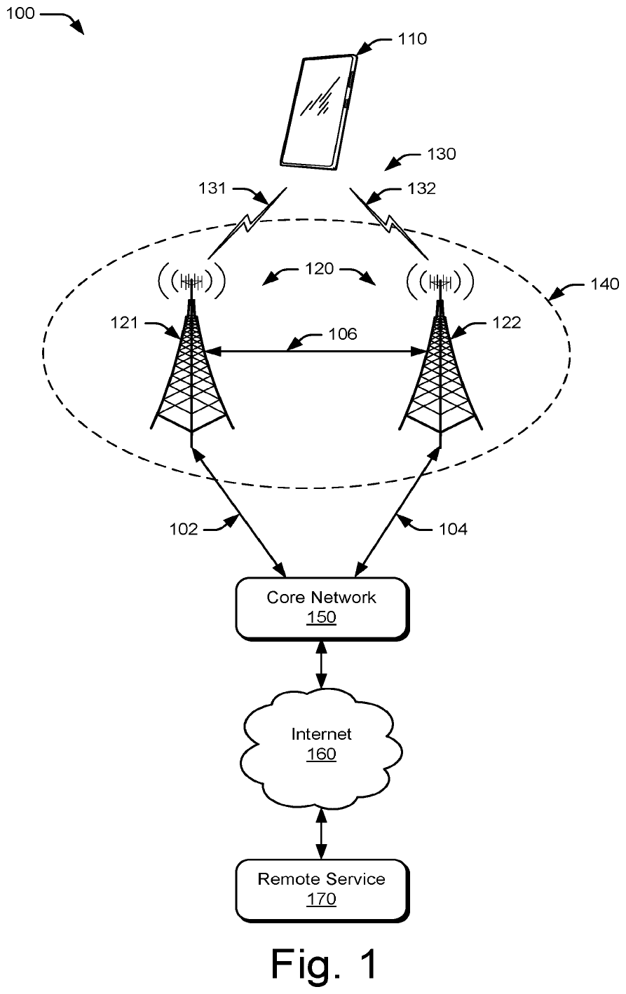

FIG. 1 illustrates an example environment 100, which includes a user equipment 110 (UE 110) that can communicate with base stations 120 (illustrated as base stations 121 and 122) through one or more wireless communication links 130 (wireless link 130), illustrated as wireless links 131 and 132. For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, distributed base station, and the like, or any combination or future evolution thereof.

The base stations 120 communicate with the user equipment 110 using the wireless links 131 and 132, which may be implemented as any suitable type of wireless link. The wireless links 131 and 132 include control and data communication, such as downlink of user-plane data and control-plane information communicated from the base stations 120 to the user equipment 110, uplink of other user-plane data and control-plane information communicated from the user equipment 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. In various aspects, the base stations 120 and UE 110 may be implemented for operation in sub-gigahertz bands, sub-6 GHz bands (e.g., Frequency Range 1), and/or above-6 GHz bands (e.g., Frequency Range 2, millimeter wave (mmWave) bands) that are defined by one or more of the 3GPP LTE, 5G NR, or 6G communication standards (e.g., 26 GHZ, 28 GHz, 38 GHz, 39 GHz, 41 GHz, 57-64 GHz, 71 GHz, 81 GHz, 92 GHz bands, 100 GHz to 300 GHz, 130 GHz to 175 GHz, or 300 GHz to 3 THz bands). Multiple wireless links 130 may be aggregated in a carrier aggregation or multi-connectivity to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN, NR RAN). The base stations 121 and 122 in the RAN 140 are connected to one or more core network(s) 150. The base stations 121 and 122 connect, at 102 and 104 respectively, to the core network(s) 150 through an NG2 interface for control-plane signaling and using an NG3 interface for user-plane data communications when connecting to a 5G core network, or using an SI interface for control-plane signaling and user-plane data communications when connecting to an Evolved Packet Core (EPC) network. The base stations 121 and 122 can communicate using an Xn Application Protocol (XnAP) through an Xn interface, or using an X2 Application Protocol (X2AP) through an X2 interface, at 106, to exchange user-plane and control-plane data. The user equipment 110 may connect, via the core network 150, to public networks, such as the Internet 160, to interact with a remote service 170.

### Example Devices

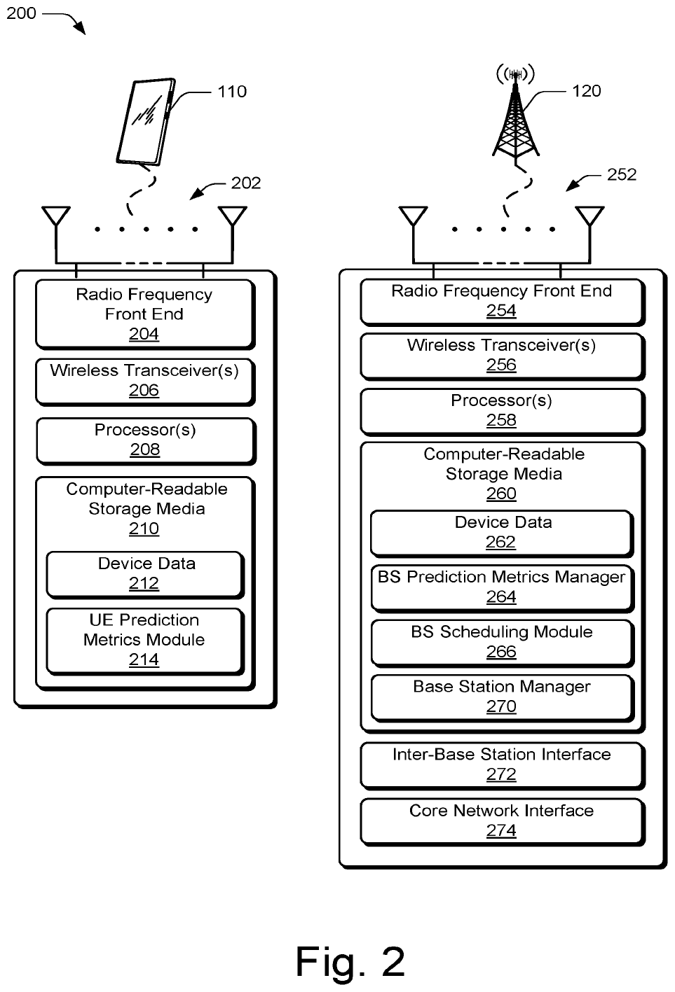

FIG. 2 illustrates an example device diagram 200 of the UE 110 and one of the base stations 120 that can implement various aspects of UE prediction metrics reporting. The UE 110 and the base station 120 may include additional functions and interfaces that are omitted from FIG. 2 for the sake of clarity.

The UE 110 includes antennas 202, a radio frequency front end 204 (RF front end 204), and one or more wireless transceiver 206 (e.g., an LTE transceiver, a 5G NR transceiver, and/or a 6G transceiver) for communicating with the base station 120 in the RAN 140. The RF front end 204 of the UE 110 can couple or connect the wireless transceiver 206 to the antennas 202 to facilitate various types of wireless communication. The antennas 202 of the UE 110 may include an array of multiple antennas that are configured in a manner similar to or different from each other. The antennas 202 and the RF front end 204 can be tuned to, and/or be tunable to, one or more frequency bands defined by the 3GPP LTE communication standards, 5G NR communication standards, 6G communication standards, and/or various satellite frequency bands, such as the L-band (1-2 Gigahertz (GHz)), the S-band (2-4 GHZ), the C-band (4-8 GHZ), the X-band (8-12 GHz), the Ku-band (12-18 GHz), K-band (18-27 GHZ), and/or the Ka-band (27-40 GHz), and implemented by the wireless transceiver 206. In some aspects, the satellite frequency bands overlap with the 3GPP LTE-defined, 5G NR-defined, and/or 6G-defined frequency bands. Additionally, the antennas 202, the RF front end 204, and/or the wireless transceiver 206 may be configured to support beamforming for the transmission and reception of communications with the base station 120. By way of example and not limitation, the antennas 202 and the RF front end 204 can be implemented for operation in sub-gigahertz (GHz) bands, sub-6 GHz bands, and/or above 6 GHz bands that are defined by the 3GPP LTE, 5G NR, 6G, and/or satellite communications (e.g., satellite frequency bands).

The UE 110 also includes one or more processor(s) 208 and computer-readable storage media 210 (CRM 210). The processor(s) 208 may be single-core processor(s) or multiple-core processor(s) composed of a variety of materials, for example, silicon, polysilicon, high-K dielectric, copper, and so on. The computer-readable storage media described herein excludes propagating signals. CRM 210 may include any suitable memory or storage device such as random-access memory (RAM), static RAM (SRAM), dynamic RAM (DRAM), non-volatile RAM (NVRAM), read-only memory (ROM), or Flash memory useable to store device data 212 of the UE 110. The device data 212 can include user data, sensor data, control data, automation data, multimedia data, machine-learning (ML) configuration codebooks, applications, and/or an operating system of the UE 110, some of which are executable by the processor(s) 208 to enable the UE 110 to exchange user-plane data wireless communications, exchange control-plane information communications, and/or provide user interaction with the UE 110.

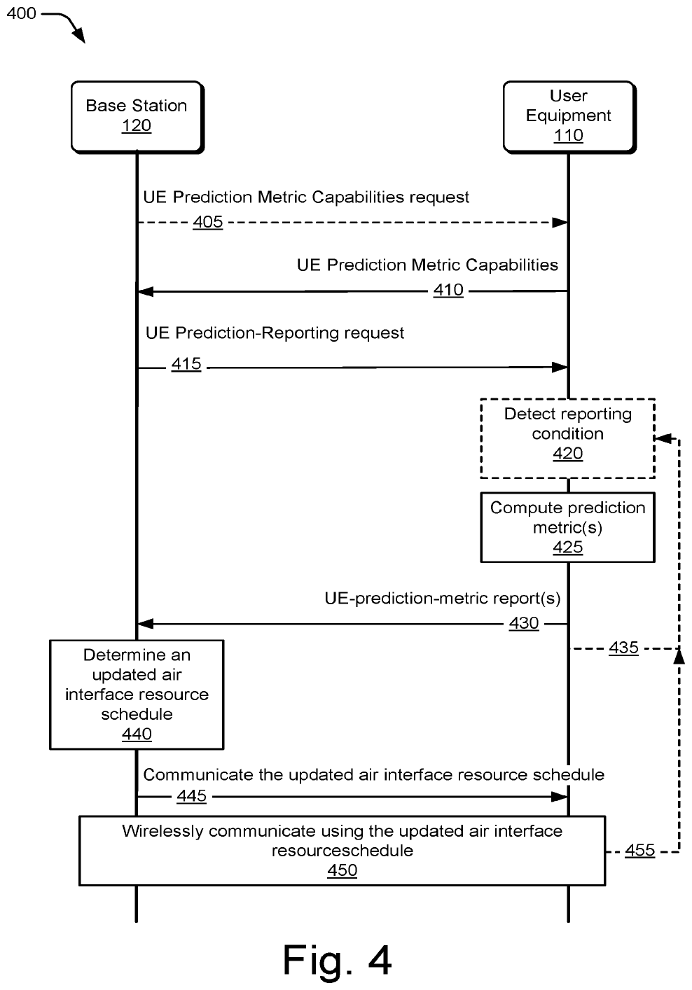

In aspects, the CRM 210 includes a user equipment prediction metrics module 214 (UE prediction metrics module 214). Alternatively, or additionally, the UE prediction metrics module 214 may be implemented in whole or part as hardware logic or circuitry integrated with or separate from other components of the user equipment 110. The UE prediction metrics module 214 uses UE-observable information (e.g., UE operating state information, UE-observed signal-quality parameters, UE-observed link-quality parameters, anticipated UE behavior) to generate prediction metrics that indicate anticipated future conditions at the UE. As one example, the UE prediction metrics module 214 generates UE operating condition prediction metrics, such as predicted uplink throughput requirements, predicted downlink throughput requirements, predicted uplink data-transfer latency requirements, predicted downlink data-transfer latency requirements, predicted Quality of Service (QOS) requirements (e.g., priority level, packet error rate (PER), packet delay budget (PDB), guaranteed bit rate, maximum data burst volume (MDBV), averaging window), predicted uplink buffer status, and so forth. This can include generating the UE operating condition prediction metrics on a per-application basis (e.g., per Internet Protocol (IP) flow) and/or on an aggregated basis (e.g., an aggregated Protocol Data Unit (PDU) session level prediction). Alternatively or additionally, the UE prediction metrics module 214 generates predicted channel condition metrics, such as uplink power headroom, downlink channel quality indicators (CQIs), channel state information (CSI) parameters, and so forth. In some aspects, the UE prediction metrics module 214 generates the prediction metrics using a machine-learning algorithm. To illustrate, the UE 110 may train a machine learning algorithm using historical data that maps various input factors (e.g., an active or anticipated application, user interactions with the UE, a current or anticipated UE location, channel conditions) to wireless communication requirements (e.g., data throughput requirements, data-transfer latency requirements, data-transfer priority levels) as further described with reference to FIG. 4.

The device diagram for the base station 120, shown in FIG. 2, includes a single network node (e.g., a gNode B). The functionality of the base station 120 may be distributed across multiple network nodes or devices and may be distributed in any fashion suitable to perform the functions described herein. The nomenclature for this distributed base station functionality varies and includes terms such as Central Unit (CU), Distributed Unit (DU), Baseband Unit (BBU), Remote Radio Head (RRH), Radio Unit (RU), and/or Remote Radio Unit (RRU). The base station 120 includes antennas 252, a radio frequency front end 254 (RF front end 254), one or more wireless transceivers 256 (e.g., one or more LTE transceivers, one or more 5G NR transceivers, and/or one or more 6G transceivers) for communicating with the UE 110. The RF front end 254 of the base station 120 can couple or connect the wireless transceivers 256 to the antennas 252 to facilitate various types of wireless communication. The antennas 252 of the base station 120 may include an array of multiple antennas that are configured in a manner similar to, or different from, each other. The antennas 252 and the RF front end 254 can be tuned to, and/or be tunable to, one or more frequency bands defined by the 3GPP LTE, 5G NR, 6G communication standards, and/or various satellite frequency bands, and implemented by the wireless transceivers 256. Additionally, the antennas 252, the RF front end 254, and the wireless transceivers 256 may be configured to support beamforming (e.g., Massive multiple-input, multiple-output (Massive-MIMO)) for the transmission and reception of communications with the UE 110.

The base station 120 also includes processor(s) 258 and computer-readable storage media 260 (CRM 260). The processor 258 may be a single-core processor or a multiple-core processor composed of a variety of materials, for example, silicon, polysilicon, high-K dielectric, copper, and so on. CRM 260 may include any suitable memory or storage device such as random-access memory (RAM), static RAM (SRAM), dynamic RAM (DRAM), non-volatile RAM (NVRAM), read-only memory (ROM), or Flash memory useable to store device data 262 of the base station 120. The device data 262 can include network scheduling data, radio resource management data, ML configuration codebooks, applications, and/or an operating system of the base station 120, which are executable by processor(s) 258 to enable communication with the UE 110.

CRM 260 includes a base station prediction metrics manager 264 (BS prediction metrics manager 264) and a base station scheduling module 266 (BS scheduling module 266). Alternatively, or additionally, the BS prediction metrics manager 264 and/or BS scheduling module 266 may be implemented in whole or part as hardware logic or circuitry integrated with or separate from other components of the base station 120. While illustrated in FIG. 2 as separate modules, alternate implementations integrate portions or all of the functionality described with respect to the BS prediction metrics manager 264 and the BS scheduling module 266 into one module.

In at least some aspects, the BS prediction metrics manager 264 and the BS scheduling module 266 communicate with one another to schedule and/or allocate air interface resources based on UE-generated prediction metrics, as further described. As one example, the BS prediction metrics manager 264 receives user-equipment-prediction-metric (UE-prediction-metric) capability information from the UE 110 and generates a prediction-metric-report-configuration communication that requests specific prediction metrics and/or prediction reporting configurations from the UE 110. To illustrate, the BS prediction metrics manager 264 specifies, in the prediction-metric-report-configuration communication, a configuration for generating the requested prediction metric (e.g., a future time window, a periodicity, a trigger event).

In aspects, the BS scheduling module 266 receives one or more UE-prediction-metric reports from one or more UEs (e.g., multiple instances of the UE 110) and schedules air interface resources based on the UE-prediction-metric reports. As one example, assume the BS scheduling module 266 analyzes a UE-prediction-metric report from the UE 110 and identifies, from one or more UE-generated prediction metrics, a predicted increase in downlink user-plane data. Based on identifying the predicted increase in downlink user-plane data, the BS scheduling module 266 schedules air interface resources to meet the predicted increase, such as by activating downlink carrier aggregation (CA) and/or activating downlink dual connectivity (DC) to the UE 110 using another base station and/or another RAT. As another example, assume the BS scheduling module 266 analyzes a UE-prediction-metric report from the UE 110 and identifies predicted high-priority and/or low-latency data transfer requirements for the UE 110. Based on identifying predicted high-priority and/or low-latency data transfer requirements, the BS scheduling module 266 performs load balancing across multiple UEs by redistributing air interface resources between the multiple UEs, such as by scheduling other UEs to different carriers. Thus, in allocating and/or scheduling the air interface resources based on a UE-prediction-metric report, the BS scheduling module may schedule, allocate, and/or reallocate resources for multiple UEs. In some aspects, the BS scheduling module 266 selects one or more modulation and coding schemes (MCS) based on predicted transmission channel conditions indicated in the UE prediction-metric report.

CRM 260 also includes a base station manager 270. Alternatively, or additionally, the base station manager 270 may be implemented in whole or part as hardware logic or circuitry integrated with or separate from other components of the base station 120. In at least some aspects, the base station manager 270 configures the wireless transceiver(s) 256 for communication with the UE 110. In aspects, the base station manager 270 communicates with and/or incorporates the functionality of the BS scheduling module 266.

The base station 120 also includes an inter-base station interface 272, such as an Xn and/or X2 interface, which the base station manager 270 configures to exchange user-plane, control-plane, and other information between other base station 120, to manage the communication of the base station 120 with the UE 110. The base station 120 includes a core network interface 274 that the base station manager 270 configures to exchange user-plane, control-plane, and other information with core network functions and/or entities.

### Example Air Interface Resources

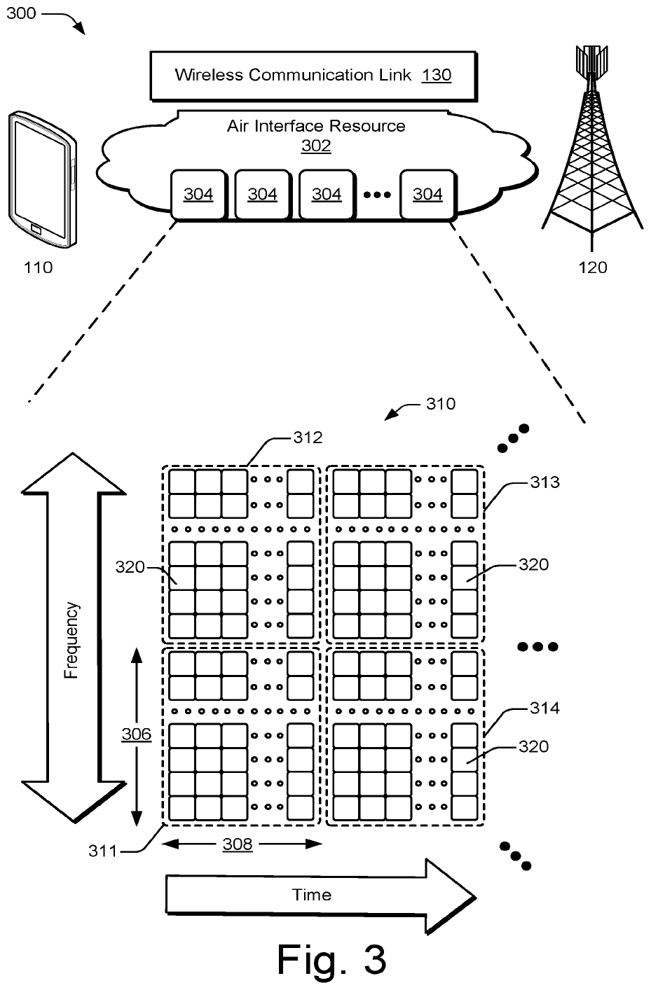

FIG. 3 illustrates an example of an air interface resource that extends between a user equipment and a base station with which various aspects of UE prediction metrics reporting can be implemented. The air interface resource 302 can be divided into resource units 304, each of which occupies some intersection of the frequency spectrum and elapsed time. A portion of the air interface resource 302 is illustrated graphically in a grid or matrix having multiple resource blocks 310, including example resource blocks 311, 312, 313, 314. An example of a resource unit 304 therefore includes at least one resource block 310. As shown, time is depicted along the horizontal dimension as the abscissa axis, and frequency is depicted along the vertical dimension as the ordinate axis. The air interface resource 302, as defined by a given communication protocol or standard, may span any suitable specified frequency range and/or may be divided into intervals of any specified duration. Increments of time can correspond to, for example, milliseconds (ms). Increments of frequency can correspond to, for example, megahertz (MHz).

In example operations generally, the base stations 120 allocate portions (e.g., resource units 304) of the air interface resource 302 for uplink and downlink communications. Each resource block 310 of network access resources may be allocated to support respective wireless communication links 130 of multiple user equipment 110. In the lower-left corner of the grid, the resource block 311 may span, as defined by a given communication protocol, a specified frequency range 306 and includes multiple subcarriers or frequency sub-bands. The resource block 311 may include any suitable number of subcarriers (e.g., 12) that each corresponds to a respective portion (e.g., 15 kHz) of the specified frequency range 306 (e.g., 180 kHz). The resource block 311 may also span, as defined by the given communication protocol, a specified time interval 308 or time slot (e.g., lasting approximately one-half millisecond or 7 orthogonal frequency-division multiplexing (OFDM) symbols). The time interval 308 includes subintervals that may each correspond to a symbol, such as an OFDM symbol. As shown in FIG. 3, each resource block 310 may include multiple resource elements 320 (REs) that correspond to, or are defined by, a subcarrier of the frequency range 306 and a subinterval (or symbol) of the time interval 308. Alternatively, a given resource element 320 may span more than one frequency subcarrier or symbol. Thus, a resource unit 304 may include at least one resource block 310, at least one resource element 320, and so forth.

### UE Prediction Metrics Reporting

Dynamic changes in a UE operating state and/or UE location sometimes makes scheduling and/or allocating air interface resources to multiple UEs difficult for a base station operating in a RAN. In aspects, a UE provides prediction metrics (e.g., predicted UE operating condition metrics, predicted signal and/or link-quality metrics) to a base station based on various factors observable at the UE. This provides the base station with additional information and time to schedule air interface resources to meet anticipated data requirements and/or mitigate anticipated problems in a corresponding transmission channel, thus allowing the base station to improve the reliability and/or performance (e.g., improved throughput, reduced bit errors) of the services provided by the RAN.

In some aspects, a UE uses machine-learning (ML) algorithms to generate prediction metrics, such as any combination of metrics corresponding to predicted uplink throughput requirements, predicted downlink throughput requirements, predicted uplink data-transfer latency requirements, predicted downlink data-transfer latency requirements, predicted QoS requirements (e.g., priority level, PER, PDB, guaranteed bit rate, MDBV, averaging window), predicted uplink buffer status, predicted uplink power headroom, predicted downlink CQIs, predicted CSI, and so forth. As one example, assume a UE records a series (over time) of downlink CQI and other UE-observed signal-quality and/or link-quality measurements, such as, by way of example and not of limitation, power headroom, signal power information, signal-to-interference-plus-noise ratio (SINR) information, channel state information (CSI), Doppler feedback, frequency bands, BLock Error Rate (BLER), Hybrid Automatic Repeat reQuest (HARQ) information (e.g., first transmission error rate, second transmission error rate, maximum retransmissions), latency, Radio Link Control (RLC), Automatic Repeat reQuest (ARQ) metrics, received signal strength (RSSI), and so forth. Alternatively or additionally, the UE records UE operating state information (e.g., active or inactive applications, data priority, data throughput, data-transfer latency, uplink buffer status, time of day, day of week) over time. In aspects, the UE uses any combination of the recorded information to train a ML algorithm (e.g., using supervised training) to predict a future CQI for a future time window (e.g., 5 milliseconds (ms) future window, 10 ms future window, 12 ms future window). However other types of training may be utilized as well, such as unsupervised training, reinforcement training, semi-supervised training, and so forth. While described as training the ML algorithm to predict a future CQI, the ML algorithm may be trained to predict alternate or additional prediction metrics as described.

To illustrate, the UE trains the ML algorithm to generate UE operating condition prediction metrics (e.g., predicted uplink throughput requirements, predicted downlink throughput requirements, predicted uplink data-transfer latency requirements, predicted downlink data-transfer latency requirements, predicted QoS requirements) using the recorded information and feedback (e.g., observed data priority, observed data throughput, observed data-transfer latency, observed uplink buffer status, observed signal-quality and/or link-quality measurements). In some aspects, the UE trains the ML algorithm to generate application-specific and/or IP-flow-specific prediction metrics (e.g., data throughput requirements specific to a particular application and/or IP-flow). Alternatively or additionally, the UE trains the ML algorithm to generate aggregated prediction metrics (e.g., aggregated data throughput requirements for multiple concurrently active applications and/or IP flows).

In some aspects, the UE trains the ML algorithm to generate the prediction metrics based on anticipated behavior of the UE. To illustrate, assume the UE periodically invokes a video conferencing application weekly on a scheduled day and/or time. In aspects, the UE records a UE operating state while the video conferencing application executes and trains the ML algorithm on the video conferencing application usage (e.g., observed data throughput, observed data-transfer latency, observed start time, observed end time, observed time duration) such that, in response to identifying an approaching instance of the weekly, periodic meeting, the ML algorithm generates prediction metrics that reflect the expected usage requirements of the video conferencing application. For instance, the ML algorithm learns, based on the recorded and/or historical information, that downlink and/or uplink data throughput for the UE increases for the periodic time of day and/or day of the week. As the periodic time of day and/or day of the week approaches, and based on training, the ML algorithm generates predicted downlink and/or uplink data throughput metrics that reflect anticipated downlink and/or uplink data throughput usage for a future time window. Alternatively or additionally, the ML algorithm identifies from input, such as calendar information, a scheduled instance of the video conferencing application occurs within a future time window. As another example of anticipated behavior, the ML algorithm may be trained to generate prediction metrics based on a mobility of the UE, such as by alternatively or additionally including global position system (GPS) and/or map tracking information in the recorded information used to train the ML algorithm. To illustrate, the UE may train the ML algorithm to identify when the UE is approaching a location that historically causes the UE to lose a connection with the base station (e.g., a tunnel, an edge of cell service).

While described as a UE performing the ML training, in alternative or additional implementations, a base station or a core network performs the described ML training (e.g., offline, using recorded input and/or mathematically generated input) and communicates an ML configuration (e.g., ML architecture configuration, weights, biases) to the UE that forms a ML algorithm that generates prediction metrics as further described. The ML configuration can include any combination of parameters and/or configurations that define the behavior of the ML algorithm, such as any combination of node connections for a neural network, coefficients, active layers for a neural network, weights, biases, pooling, etc. In some aspects, the base station communicates the ML configuration to the UE by indicating an entry of a synchronized ML configuration codebook.

FIG. 4 illustrates an example signaling and data transaction diagram 400 between a base station and a user equipment in accordance with one or more aspects of UE prediction metrics reporting. In implementations, the signaling and data transactions may be performed by any combination of the base station 120 (FIG. 1) and the UE 110 (FIG. 1) using elements of FIGS. 1-3. The diagram 400 denotes optional transactions using dashed lines.

As illustrated, at 405 the base station 120 optionally requests UE-prediction-metric capabilities from the UE 110. For instance, the base station 120 sends a radio resource control (RRC) message that includes a user-equipment-capability-enquiry (UECapabilityEnquiry) information element (IE) that indicates a request for UE-prediction-metric capabilities from the UE 110. To illustrate, the base station 120 configures the UECapabilityEnquiry IE to request the UE-prediction-metric capabilities, such as through the inclusion of a toggle field, a Boolean value, an enum value, and so forth. In one example, the base station 120 sends the UECapabilityEnquiry IE in the RRC message during a registration process. In aspects, the base station 120 explicitly requests information about specific UE-prediction metrics. The base station 120, for instance, explicitly requests capability information for downlink data throughput prediction metrics, uplink data throughput prediction metrics, and uplink buffer status prediction metrics. In other aspects, the base station 120 generically requests UE-prediction-metric capabilities without explicitly specifying any prediction metrics in the request.

At 410, the UE 110 communicates UE-prediction-metric capabilities supported by the UE to the base station 120. To illustrate, the UE 110 sends an RRC message that includes UE-prediction-metrics-capability information, such as any combination of predicted uplink throughput requirements, predicted downlink throughput requirements, predicted uplink data-transfer latency requirements, predicted downlink data-transfer latency requirements, predicted QoS requirements, predicted uplink buffer status, and so forth, supported by the UE. The UE 110 may alternatively or additionally indicate whether the UE 110 supports generating various prediction metrics on a per-application basis and/or on an aggregated basis. The UE 110 may communicate the UE-prediction-metric capabilities in response to receiving the UECapabilityEnquiry IE as described at 405 or as part of other processes in which the UE communicates capabilities. As one example, the UE 110 communicates the UE-prediction-metric capabilities in a user-equipment-capability (UECapability) information element.

In some aspects, the UE 110 indicates support for various prediction reporting configurations that may be used in generating the prediction metrics. As one example, the UE 110 indicates a shortest time window that specifies the shortest time window to a future time the UE supports for generating a prediction metric. To illustrate, by specifying 5 ms as the shortest time window, the UE 110 indicates support for generating a corresponding prediction metrics for no shorter than 5 ms into the future time window. The UE 110 may alternatively or additionally indicate a longest time window that specifies the longest time window the UE supports for generating a prediction metric in a future time window. In aspects, the UE indicates a respective shortest and/or longest time window for each supported prediction metric or generically indicates the shortest and/or the longest time window such that the indicated shortest and/or longest time window applies to all supported prediction metrics.

As another example of a prediction reporting configuration capability, the UE 110 may indicate support for generating the prediction metrics on a per-application basis and/or an aggregated basis. Similar to the shortest and/or longest time window, this may include indicating time windows on a per-application basis and/or aggregated basis. Alternatively or additionally, the UE 110 generically indicates support for generating the prediction metrics on a per-application basis and/or an aggregated basis for all prediction metrics and/or a subset of prediction metrics.

As another example of a prediction reporting configuration capability, the UE 110 may indicate support for providing a confidence interval, an error percentage, and/or a prediction accuracy of a reported UE prediction metric. As similarly described above, this may include indicating support for returning respective confidence interval, error percentages, and/or prediction accuracies for each respective prediction metric.

Some implementations of the UE 110 reports the supported prediction metrics as a list. For instance, the UE 110 returns, in the UE-prediction-metric capabilities communication, a series and/or list of supported prediction metrics and specifies supported configurations for each prediction metric. To illustrate, the UE 110 returns, for each supported prediction metric, an identifier and/or name of the supported prediction metric, a shortest and/or longest future time window supported for the prediction metric, and a prediction accuracy and/or confidence level metric for the predicted metric.

At 415, the base station 120 communicates a prediction-reporting request configuration to the UE 110 that directs the UE 110 to generate prediction-metric reports. To illustrate, the base station 120 transmits an RRC message to the UE 110 that indicates, in the prediction-reporting request, a set of requested prediction metrics. Alternatively or additionally, the base station 120 communicates, in the prediction-reporting request, a prediction reporting configuration for each requested prediction metric in the set. This can include the base station 120 specifying, in the prediction-reporting request, reporting conditions that indicate when to report the prediction metrics.

As one example, the base station 120 selects a set of requested prediction metrics based on the UE-prediction-metric capabilities sent at 410 (e.g., in a UECapability IE) and specifies the set of requested prediction metrics in the prediction-reporting request, such as in a prediction object that includes the set of requested prediction metrics. Alternatively or additionally, the base station 120 selects one or more prediction reporting configurations that indicate, to the UE 110, parameters for generating the prediction metrics. The prediction reporting configurations may be associated with and/or included in the prediction object.

As one example, the base station 120 specifies, in the prediction reporting configuration, a time window for each prediction metric based on a shortest and/or longest time window supported by the UE 110 (and indicated at 410). This can include specifying a respective time window for each requested prediction metric in the set of requested prediction metrics (e.g., different time windows for each requested prediction metrics), a common time window for each respective prediction metric in the set of requested prediction metrics, and/or different common time windows for subsets of requested prediction metrics in the set of requested prediction metrics. In some aspects, the base station 120 selects the time window based on known scheduling latencies at the base station 120.

Alternatively or additionally, the base station 120 specifies, as a prediction report configuration, reporting conditions that indicate when to generate and/or report the prediction metrics. The base station 120 may specify the reporting conditions collectively (e.g., one reporting condition applied to all requested prediction metrics in the set, a subset of requested prediction metrics in the set) or respectively for each prediction metric (e.g., a different reporting condition for each requested prediction metric). To illustrate, the base station 120 specifies a periodic time window and/or duration that directs the UE 110 to report the requested prediction metric on a periodic basis. As another example, the base station 120 specifies a trigger event, such as a threshold value that directs the UE 110 to report the requested prediction metric in response to identifying when the requested prediction metric changes more than the threshold value and/or when the requested prediction metric exceeds or falls below the threshold value.

In some aspects, the base station 120 specifies, in the prediction reporting configuration and/or the prediction object, radio frequency (RF) characteristics and/or attributes for at least some requested prediction metrics in the set, such as carrier frequency attributes and/or frequency band attributes. To illustrate, the base station 120 specifies one or more carrier frequencies and/or frequency bands for signal-quality and/or link-quality prediction metrics to indicate a request to report a corresponding prediction metric for each specified carrier frequency and/or frequency band. However, for some requested prediction metrics, the base station 120 does not specify RF characteristics, such as for various UE operating condition prediction metrics (e.g., uplink and/or downlink data throughput, uplink and/or downlink data latency, uplink and/or downlink data priority).

In communicating the prediction-reporting request to the UE 110, the base station may communicate multiple prediction objects in combination with one or more prediction report configurations. For instance, the base station 120 may determine and/or identify a first set of requested prediction metrics for a first prediction object and a second set of requested prediction metrics for a second prediction object, where the first set and the second set specify different combinations of prediction metrics. The base station 120 alternatively or additionally determines and/or specifies a first prediction report configuration and a second prediction report configuration, where the first prediction report configuration and the second prediction report configuration specify different prediction report configurations (e.g., different time windows, different reporting conditions). In aspects, the base station 120 specifies, in the prediction-reporting request, one or more prediction identities that associate a prediction report configuration with a prediction object. To illustrate, a first prediction identity corresponds to associating the first prediction report configuration with the first prediction object and a second prediction identify corresponds to associating the second prediction report configuration with the second prediction object. Thus, in some aspects, associating a prediction report configuration with a prediction object implicitly indicates to use the prediction reporting configuration for each requested prediction metric identified in the prediction object.

At 420, the UE 110 optionally detects a reporting condition and at 425, the UE 110 computes one or more prediction metrics based on a corresponding reporting configuration indicated at 415. Alternatively or additionally, for some prediction metrics, the UE first computes the prediction metrics and then detects the reporting condition. As one example, the UE 110 detects the occurrence and/or recurrence of a periodic time duration at 420 and computes the one or more prediction metrics. Alternatively or additionally, the UE 110 computes the one or more prediction metrics at 425 (e.g., periodically) and determines to report the one or more prediction metrics in response to detecting the reporting condition. For instance, the UE 110 detects that the one or more computed prediction metrics have changed more than a threshold value.

At 425, the UE 110 computes one or more prediction metrics, such as prediction metrics generated through a trained ML algorithm. As described, this includes the UE computing any combination of prediction metrics, such as predicted uplink and/or downlink data throughput requirements, predicted uplink and/or downlink data latency requirements, predicted uplink buffer status, predicted QoS requirements, predicted signal-quality and/or link-quality metrics, etc. Accordingly, in response to detecting a reporting condition at 420 and/or in response to computing one or more prediction metrics, the UE 110 communicates one or more UE-prediction-metric reports to the base station 120 at 430, where the UE-prediction-metric report(s) include the prediction metrics computed at 425.

At 435, the UE 110 optionally repeats detecting reporting conditions as described at 420, computing prediction metrics as described at 425, and communicating the UE-prediction-metric reports at 430. To illustrate, assume the base station 120 communicates, at 415, a periodic prediction reporting configuration such that the UE 110 periodically computes and sends prediction metrics. As another example, the UE 110 periodically computes the prediction metrics and detects, multiple times, that changes in computed prediction metrics repeatedly change a threshold value.

At 440, the base station 120 determines an updated air interface resource schedule based on the prediction metrics communicated at 430. To illustrate, and as described with reference to FIG. 2, the BS scheduling module 266 (not shown in FIG. 4) of the base station 120 analyzes a UE-prediction-metric report from the UE 110 and identifies a predicted increase in downlink user-plane data. Based on identifying predicted increase in downlink user-plane data, the BS scheduling module 266 schedules air interface resources to meet the predicted increase, such as by activating downlink CA and/or downlink DC with the UE 110 and increasing an allocation of air interface resources to the UE 110. As another example, assume the BS scheduling module 266 analyzes a UE-prediction-metric report from the UE 110 and identifies predicted high-priority and/or low-latency data transfer requirements for the UE 110. Based on identifying predicted high-priority and/or low-latency data transfer requirements, the BS scheduling module 266 performs load balancing across multiple UEs (not shown in FIG. 4), such as by redistributing air interface resources between the multiple UEs. To illustrate, the BS scheduling module 266 schedules the multiple UEs across different carriers. In scheduling the air interface resources, the base station 120 may select one or more modulation and coding schemes (MCS) to mitigate predicted transmission channel conditions.

In some aspects, the BS scheduling module 266 redistributes the air interface resources using prediction-metric reports from multiple UEs. For example, assume the base station 120 receives a first prediction-metric report from the UE 110 that predicts a future need for low data-transfer latency during a specified (future) time window, and a second prediction-metric report from a second UE (not show in FIG. 4) that predicts the second UE can tolerate a high data-transfer latency during the same, specified time window. Because the second UE can tolerate the high data-transfer latency during the same specified time window that the first UE has a need for a low data-transfer latency, the BS scheduling module 266 redistributes (e.g., reassigns) air interface resources from the second UE to the first UE during at least the specified (future) time window to meet the low data-transfer latency requirement of the first UE.

At 445, the base station 120 communicates the updated air interface resource schedule (e.g., an updated resource grant) to the UE 110. For visual clarity, the diagram 400 illustrates this communication as a single arrow, but multiple bi-directional communications may be used to communicate the updated air interface resource schedule, such as communications between the base station 120 and the UE 110 to enable or disable CA, enable or disable DC, communicate an updated allocation of air interface resources, communications with between the base station 120 and other UEs when load balancing (not show in FIG. 4), communications with other base stations, and so forth. The base station 120 may determine to enable and/or disable any combination of uplink CA, downlink CA, uplink DC downlink DC, and so forth. Accordingly, at 450, the base station 120 and the UE 110 wirelessly communicate using the updated air interface resource schedule.

At 455, and as similarly described at 435, the UE 110 optionally repeats detecting reporting conditions as described at 420, computing prediction metrics as described at 425, and communicating the UE-prediction-metric reports at 430. In response to receiving additional UE-prediction-metric reports as shown at 430, the base station may determine an additional updated air interface resource schedule as described at 440, communicate the additional updated air interface resource schedule to the UE 110 as described at 445, and wirelessly communicate with the UE 110 using the additional updated air interface resource schedule as described at 450.

UE-generated prediction metrics provide the base station with additional information otherwise unknown to the base station. UE-generated prediction metrics also provide the base station with additional time to select and deploy scheduling that can be used to improve how the base station communicates with the UE. This helps improves the reliability of the services provided by the RAN by quickly responding to changes at the UE, such as changes in a UE operating condition and/or UE location.

### Example Methods

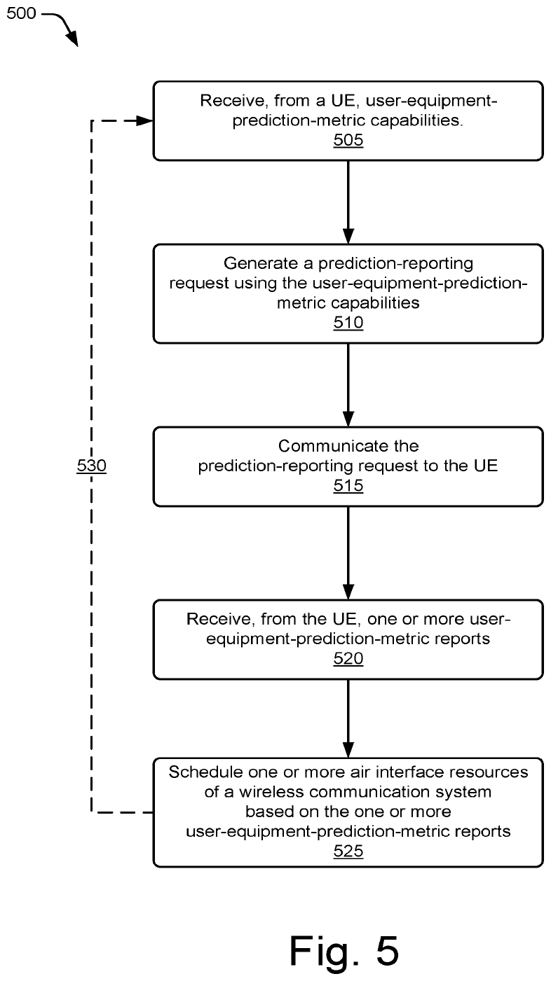

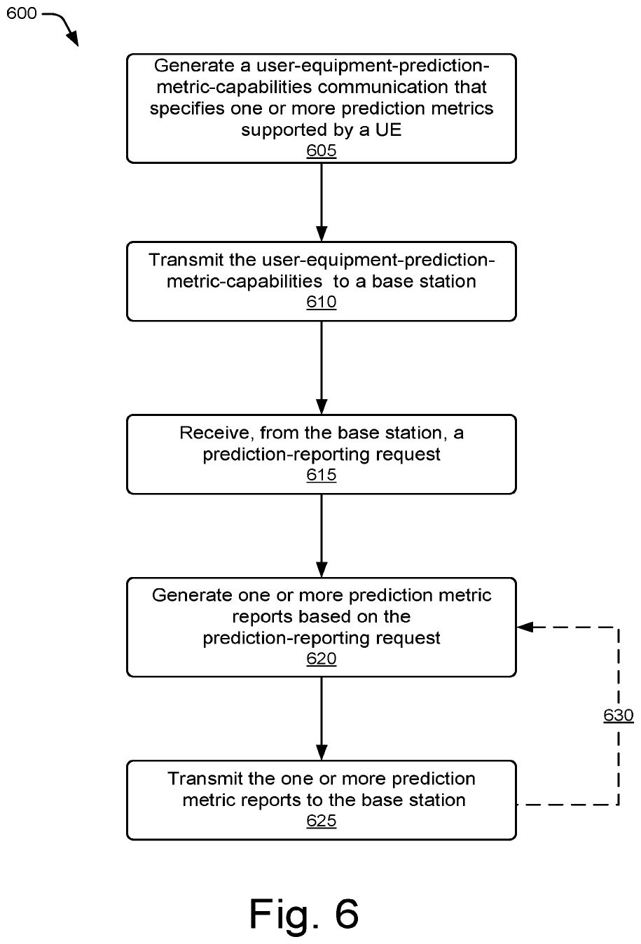

Example methods 500 and 600 are described with reference to FIGS. 5 and 6 in accordance with one or more aspects of UE prediction metrics reporting. FIG. 5 illustrates an example method 500 for scheduling air interface resources of a wireless communication system using one or more prediction metrics from a UE. In aspects, operations of the method 500 are performed by a base station, such as the base station 120.

At 505, a base station receives, from a UE, user-equipment-prediction-metric capabilities. As one example, the base station 120 receives UE prediction metric capabilities from the UE 110 as described at 410 of FIG. 4. In some aspects, the base station receives the user-equipment-prediction-metric capabilities in response to an enquiry sent by the base station, as described at 405 of FIG. 4.

At 510, the base station generates a prediction-reporting request using the user-equipment-prediction-metric capabilities. To illustrate, and as described at 415 of FIG. 4, the base station 120 selects a set of requested prediction metrics, determines a prediction-reporting configuration for the set of requested prediction metrics, and/or generates the prediction-reporting request using the set of requested prediction metrics and/or the prediction-reporting configuration.

At 515, the base station communicates the prediction-reporting request to the user equipment. The base station 120, for instance, transmits an RRC message to the UE 110 as described at 415 of FIG. 4, where the RRC message includes any combination of a prediction object, a set of requested prediction metrics, and/or a prediction-reporting configuration.

At 520, the base station receives, from the UE, one or more user-equipment-prediction-metric reports. For example, the base station 120 receives one or more UE prediction metric reports from the UE 110 as described at 430 of FIG. 4

At 525, the base station schedules one or more air interface resources of a wireless communication system based on the one or more user-equipment-prediction-metric reports. To illustrate, the base station 120 determines to enable and/or disable CA based on the UE-prediction-metric reports and schedules updated air interface resources based on enabling and/or disabling CA as described at 440 of FIG. 4.

In some aspects, the method 500 iteratively repeats as indicated at 530. For instance, as described at 455 of FIG. 4, the base station 120 receives updated UE prediction-metric reports from the UE 110 and determines an updated allocation of air interface resources using the updated UE prediction-metrics reports.

FIG. 6 illustrates an example method 600 for scheduling air interface resources of a wireless communication system using one or more prediction metrics from a UE. In aspects, operations of the method 600 are performed by a user equipment, such as the UE 110.

At 605, a user equipment generates a user-equipment-prediction-metric-capabilities communication that specifies one or more prediction metrics supported by the user equipment. To illustrate, the UE 110 generates a UE-prediction-metric capabilities message as described at 410 of FIG. 4. In some aspects, the UE generates the UE-prediction-metric capabilities message in response to receiving an enquiry message from the base station as described at 405 of FIG. 4.

At 610, the UE transmits the user-equipment-prediction-metric-capabilities communication to a base station. For instance, as described at 410 of FIG. 4, the UE 110 transmits an RRC message that includes the UE-prediction-metric capabilities to the base station 120.

At 615, the UE receives, from the base station, a prediction-reporting configuration. In one example, and as described at 415 of FIG. 4, the UE 110 receives an RRC message from the base station 120, where the RRC message includes any combination of a prediction object, a set of requested prediction metrics, and/or the prediction reporting configuration.

At 620, the UE generates one or more prediction-metric reports based on the prediction-reporting configuration. To illustrate, and as described at 420 and/or 425 of FIG. 4, the UE 110 optionally detects a reporting condition, computes one or more prediction metrics, and determines to report a prediction-metric report to the base station 120.

At 625, the UE transmits the one or more prediction metric reports to the base station. The UE 110, for instance, transmits one or more UE-prediction-metric reports to the base station 120 as described at 430 of FIG. 4.

In some aspects, the method 600 iteratively repeats as indicated at 630. For instance, as described at 420 and/or 425, the UE detects a reporting condition, computes one or more prediction metrics, and determines to transmit the prediction metrics to the base station 120.

Although aspects of UE prediction metrics reporting have been described in language specific to features and/or methods, the subject of the appended claims is not necessarily limited to the specific features or methods described. Rather, the specific features and methods are disclosed as example implementations of UE prediction metrics reporting, and other equivalent features and methods are intended to be within the scope of the appended claims. Further, various different aspects are described, and it is to be appreciated that each described aspect can be implemented independently or in connection with one or more other described aspects.

In the following text, some examples are described.

Example 1: A method implemented by a base station for scheduling air interface resources of a wireless communication system using one or more prediction metrics from a user equipment, UE, the method comprising:
receiving, from the user equipment, user-equipment-prediction-metric capabilities;
generating a prediction-reporting request using the user-equipment-prediction-metric capabilities;
communicating the prediction-reporting request to the user equipment;
receiving, from the user equipment, one or more user-equipment-prediction-metric reports; and
scheduling one or more air interface resources of a wireless communication system based on the one or more user-equipment-prediction-metric reports.

Example 2: The method as recited in claim 1, further comprising:
detecting, based on analyzing the user-equipment-prediction-metric capabilities, that the user equipment supports one or more of:
a Quality of Service, QoS, requirement prediction metric;
an uplink buffer status prediction metric;
an uplink or downlink data throughput prediction metric;
an uplink or downlink data-transfer latency prediction metric; or
a Quality of Service, QoS, requirement prediction metric.

Example 3: The method as recited in claim 1 or claim 2, further comprising:
detecting, based on analyzing the user-equipment-prediction-metric capabilities, that the user equipment supports one or more of:
per-application prediction metrics; or
aggregated protocol data unit, PDU, session level prediction metrics.

Example 4: The method as recited in any one of claims 1 to 3, wherein receiving the user-equipment-prediction-metric capabilities further comprises:
receiving the user-equipment-prediction-metric capabilities in a user-equipment-capability information element.

Example 5: The method as recited in any one of claims 1 to 4, further comprising:
detecting, based on analyzing the user-equipment-prediction-metric capabilities, that the user equipment supports at least one signal-quality or link-quality prediction metric.

Example 6: The method as recited in any one of claims 1 to 5, further comprising:
detecting, based on analyzing the user-equipment-prediction-metric capabilities, at least one of:
a shortest time window supported by the user equipment; or
a longest time window supported by the user equipment.

Example 7: The method as recited in any one of claims 1 to 6, further comprising:
detecting, based on analyzing the user-equipment-prediction-metric capabilities, at least one of:
a prediction accuracy for one or more prediction metrics supported by the user equipment; or
a confidence level for the one or more prediction metrics supported by the user equipment.

Example 8: The method as recited in any one of claims 1 to 7, wherein generating the prediction-reporting request further comprises:
selecting one or more prediction metrics indicated by the user equipment through the received user-equipment-prediction-metric capabilities; and
including the selected one or more prediction metrics in the prediction-reporting request.

Example 9: The method as recited in claim 8, wherein generating the prediction-reporting request further comprises:
specifying, for each of the selected one or more prediction metrics, a respective prediction-reporting configuration.

Example 10: The method as recited in claim 9, further comprising:
determining a time window based, at least in part, on a scheduling latency at the base station; and
specifying, in the prediction-reporting configuration, the time window.

Example 11: The method as recited in any one of claims 8 to 10, wherein generating the prediction-reporting request further comprises:
specifying, for at least one of the selected one or more prediction metrics, a frequency band or a carrier frequency.

Example 12: The method as recited in any one of claims 8 to 11, wherein generating the prediction-reporting request further comprises:
excluding, for at least one of the selected one or more prediction metrics, a radio frequency, RF, characteristic.

Example 13: The method as recited in any one of claims 8 to 12, wherein generating the prediction-reporting request further comprises:
specifying, for at least one of the selected one or more prediction metrics, a reporting condition.

Example 14: The method as recited in claim 13, wherein the reporting condition comprises:
a periodic time window or a trigger event.

Example 15: The method as recited in any one of claims 8 to 14, wherein generating the prediction-reporting request further comprises:
specifying, for a first prediction metric of the selected one or more prediction metrics, a first prediction-reporting configuration; and
specifying, for a second prediction metric of the one or more prediction metrics, a second prediction-reporting configuration that is different from the first prediction-reporting configuration.

Example 16: The method as recited in any one of claims 1 to 15, wherein transmitting the prediction-reporting request further comprises:
transmitting the prediction-reporting request to the user equipment using a Radio Resource Control message, RRC message.

Example 17: The method as recited in any one of claims 1 to 16, wherein scheduling the one or more air interface resources based on the one or more user-equipment-prediction-metric reports further comprises:
determining an uplink or downlink carrier aggregation configuration based on at least one user-equipment-prediction-metric report of the one or more user-equipment-prediction-metric reports; and
scheduling the one or more air interface resources using the uplink or downlink carrier aggregation configuration.

Example 18: The method as recited in any one of claims 1 to 17, wherein the user equipment is a first user equipment, and
wherein scheduling the one or more air interface resources further comprises:
redistributing the one or more air interface resources between the first user equipment and at least a second user equipment operating in the wireless communication system.

Example 19: The method as recited in claim 18, wherein redistributing the one or more air interface resources between the first user equipment and at least a second user equipment further comprises:
receiving at least a second prediction-metric report from the second user equipment; and
redistributing the one or more air interface resources between the first user equipment and at least the second user equipment based on the one or more user-equipment-prediction-metric reports received from the first user equipment and the second prediction-metric report received form the second user equipment.

Example 20: The method as recited in any one of claims 1 to 19, wherein scheduling the one or more air interface resources further comprises:
scheduling one or more modulation and coding schemes, MCS, based on at least one user-equipment-prediction-metric report of the one or more user-equipment-prediction-metric reports.

Example 21: A method implemented by a user equipment, UE, for communicating one or more one or more prediction metrics to a base station, the method comprising:
generating a user-equipment-prediction-metric-capabilities communication that specifies one or more prediction metrics supported by the user equipment;
transmitting the user-equipment-prediction-metric-capabilities communication to the base station;
receiving, from the base station, a prediction-reporting request;
generating one or more prediction metric reports based on the prediction-reporting request; and
transmitting the one or more prediction metric reports to the base station.

Example 22: The method as recited in claim 21, further comprising:
indicating, in the user-equipment-prediction-metric-capabilities communication, that the user equipment supports one or more of:
a Quality of Service, QOS, requirement prediction;
an uplink buffer status prediction metric;
an uplink or downlink data throughput prediction metric;
an uplink or downlink data-transfer latency requirement prediction metric; or
a Quality of Service, QoS, of application traffic prediction metric.

Example 23: The method as recited in claim 21 or claim 22, further comprising:
indicating in the user-equipment-prediction-metric-capabilities communication that the user equipment supports one or more of:
per application prediction metrics; or
aggregated protocol data unit, PDU, session level prediction metrics.

Example 24: The method as recited in any one of claims 21 to 23, wherein transmitting the user-equipment-prediction-metric-capabilities communication further comprises:
transmitting the user-equipment-prediction-metric-capabilities communication in a user-equipment-capability information element.

Example 25: The method as recited in any one of claims 21 to 24, further comprising:
indicating in the user-equipment-prediction-metric-capabilities communication that the user equipment supports at least one signal-quality or link-quality prediction metric.

Example 26: The method as recited in any one of claims 21 to 25, further comprising:
indicating in the user-equipment-prediction-metric-capabilities communication at least one of:
a shortest time window supported by the user equipment; or
a longest time window supported by the user equipment.

Example 27: The method as recited in any one of claims 21 to 26, further comprising:
indicating in the user-equipment-prediction-metric-capabilities communication at least one of:
a prediction accuracy for one or more prediction metrics supported by the user equipment; or
a confidence level for the one or more prediction metrics supported by the user equipment.

Example 28: The method as recited in any one of claims 21 to 27, further comprising:
identifying one or more requested prediction metrics in the prediction-reporting request.

Example 29: The method as recited in claim 28, further comprising:
identifying, for at least one requested prediction metric of the one or more requested prediction metrics, a future time window; and
generating a prediction-metric report for the at least one requested prediction metric for the future time window.

Example 30: The method as recited in claim 28 or claim 29, further comprising:
identifying, for at least one requested prediction metric of the one or more requested prediction metrics, a frequency band attribute; and
generating a predicted metric report for the at least one requested prediction metric based on the frequency band attribute.

Example 31: The method as recited in any one of claims 28 to 30, further comprising:
excluding, for at least one of the one or more requested prediction metrics, a frequency band attribute.

Example 32: The method as recited in any one of claims 28 to 31, further comprising:
identifying, for at least one requested prediction metric of the one or more requested prediction metrics, a reporting condition;
detecting the reporting condition; and
generating a predicted metric report for the at least one requested prediction metric in response to detecting the reporting condition.

Example 33: The method as recited in claim 32, wherein the reporting condition comprises:
a periodic time duration or a trigger event.

Example 34: The method as recited in any one of claims 28 to 33, further comprising
identifying, for a first prediction metric of the requested prediction metrics, a first prediction-reporting configuration;
identifying, for a second prediction metric of the requested prediction metrics, a second prediction-reporting configuration that is different from the first prediction-reporting configuration;
generating a first predicted metric report for the first prediction metric based on the first prediction-reporting configuration; and
generating a second prediction metric report for the second prediction metric based on the second prediction-reporting configuration.

Example 35: The method as recited in any one of claims 21 to 34, further comprising:
receiving the prediction-reporting request in a Radio Resource Control message, RRC message.

Example 36: An apparatus comprising:
a wireless transceiver;
a processor; and
computer-readable storage media comprising instructions that, responsive to execution by the processor, direct the apparatus to perform a method as recited in any one of claims 1 to 35.

1. A method implemented by a base station for scheduling air interface resources of a wireless communication system using one or more prediction metrics from a user equipment, UE, the method comprising:
receiving, from the user equipment, user-equipment-prediction-metric capabilities;
generating a prediction-reporting request using the user-equipment-prediction-metric capabilities;
communicating the prediction-reporting request to the user equipment;
receiving, from the user equipment, one or more user-equipment-prediction-metric reports; and
scheduling one or more air interface resources of a wireless communication system based on the one or more user-equipment-prediction-metric reports.

2. The method as recited in claim 1, further comprising:
detecting, based on analyzing the user-equipment-prediction-metric capabilities, that the user equipment supports one or more of:
a Quality of Service, QoS, requirement prediction metric;
an uplink buffer status prediction metric;
an uplink or downlink data throughput prediction metric;
an uplink or downlink data-transfer latency requirement prediction metric;
a priority level;
a packet error rate (PER);
a packet delay budget (PDB);
a guaranteed bit rate;
a maximum data burst volume (MDBV); or
an averaging window.

3. The method as recited in claim 1, further comprising:
detecting, based on analyzing the user-equipment-prediction-metric capabilities, that the user equipment supports one or more of:
per-application prediction metrics; or
aggregated protocol data unit, PDU, session level prediction metrics.

4. The method as recited in claim 1, further comprising:
detecting, based on analyzing the user-equipment-prediction-metric capabilities, at least one of:
a shortest time window supported by the user equipment; or
a longest time window supported by the user equipment.

5. The method as recited in claim 1, further comprising:
detecting, based on analyzing the user-equipment-prediction-metric capabilities, at least one of:
a prediction accuracy for the one or more prediction metrics supported by the user equipment; or
a confidence level for the one or more prediction metrics supported by the user equipment.

6. The method as recited in claim 1, wherein generating the prediction-reporting request further comprises:
selecting the one or more prediction metrics indicated by the user equipment through the received user-equipment-prediction-metric capabilities;
including the selected one or more prediction metrics in the prediction-reporting request;
specifying, for each of the selected one or more prediction metrics, a respective prediction-reporting configuration;
determining a time window based, at least in part, on a scheduling latency at the base station; and
specifying, in the respective prediction-reporting configuration, the time window.

7. The method as recited in claim 6, wherein generating the prediction-reporting request further comprises:
excluding, for at least one of the selected one or more prediction metrics, a radio frequency, RF, characteristic.

8. The method as recited in claim 6, wherein generating the prediction-reporting request further comprises:
specifying, for a first prediction metric of the selected one or more prediction metrics, a first prediction-reporting configuration; and
specifying, for a second prediction metric of the one or more prediction metrics, a second prediction-reporting configuration that is different from the first prediction-reporting configuration.

9. A method implemented by a user equipment, UE, for communicating one or more prediction metrics to a base station, the method comprising:
generating a user-equipment-prediction-metric-capabilities communication that specifies the one or more prediction metrics supported by the user equipment;
transmitting the user-equipment-prediction-metric-capabilities communication to the base station;
receiving, from the base station, a prediction-reporting request;
generating one or more prediction metric reports based on the prediction-reporting request; and
transmitting the one or more prediction metric reports to the base station.

10. The method as recited in claim 9, further comprising:
indicating, in the user-equipment-prediction-metric-capabilities communication, that the user equipment supports one or more of:
a Quality of Service, QoS, requirement prediction;
an uplink buffer status prediction metric;
an uplink or downlink data throughput prediction metric;
an uplink or downlink data-transfer latency requirement prediction metric;
a priority level;
a packet error rate (PER);
a packet delay budget (PDB);
a guaranteed bit rate;
a maximum data burst volume (MDBV); or
an averaging window.

11. The method as recited in claim 9, further comprising:
indicating in the user-equipment-prediction-metric-capabilities communication that the user equipment supports one or more of:
per application prediction metrics; or
aggregated protocol data unit, PDU, session level prediction metrics.

12. The method as recited in claim 9, further comprising:
indicating in the user-equipment-prediction-metric-capabilities communication at least one of:
a shortest time window supported by the user equipment; or
a longest time window supported by the user equipment.

13. The method as recited in claim 9, further comprising:
indicating in the user-equipment-prediction-metric-capabilities communication at least one of:
a prediction accuracy for the one or more prediction metrics supported by the user equipment; or
a confidence level for the one or more prediction metrics supported by the user equipment.

14. The method as recited in claim 13, further comprising:
excluding, for at least one of the one or more prediction metrics, a frequency band attribute.

15. (canceled)

16. The method as recited in claim 9, wherein the one or more prediction metric reports is generated using a machine learning.

17. A network entity apparatus comprising:
a processor;
wireless communication hardware; and
computer-readable storage media storing instructions that, when executed by the processor, cause the processor and the wireless communication hardware to:
receive, from a user equipment, user-equipment-prediction-metric capabilities;
generate a prediction-reporting request using the user-equipment-prediction-metric capabilities;
communicate the prediction-reporting request to the user equipment;
receive, from the user equipment, one or more user-equipment-prediction-metric reports; and
schedule one or more air interface resources of a wireless communication system based on the one or more user-equipment-prediction-metric reports.

18. The network entity apparatus as recited in claim 17, wherein the instructions that, when executed by the processor, cause the processor and the wireless communication hardware to:
detect, based on analyzing the user-equipment-prediction-metric capabilities, that the user equipment supports one or more of:
a Quality of Service, QoS, requirement prediction metric;
an uplink buffer status prediction metric;
an uplink or downlink data throughput prediction metric;
an uplink or downlink data-transfer latency requirement prediction metric;
a priority level;
a packet error rate (PER);
a packet delay budget (PDB);
a guaranteed bit rate;
a maximum data burst volume (MDBV); or
an averaging window.

19. The network entity apparatus as recited in claim 17, wherein the instructions that, when executed by the processor, cause the processor and the wireless communication hardware to:
detect, based on analyzing the user-equipment-prediction-metric capabilities, that the user equipment supports one or more of:
per-application prediction metrics; or
aggregated protocol data unit, PDU, session level prediction metrics.

20. The network entity apparatus as recited in claim 17, wherein the instructions that, when executed by the processor, cause the processor and the wireless communication hardware to:
detect, based on analyzing the user-equipment-prediction-metric capabilities, at least one of:
a shortest time window supported by the user equipment; or
a longest time window supported by the user equipment.
